(19) United States
(12) Patent Application Publication
(10) Pub. No.: US 2023/0393532 A1
(43) Pub. Date: Dec. 7, 2023

(54) WATCHCASE BASE BODY, WATCH AND METHOD FOR MANUFACTURING A WATCH

(71) Applicant: Porsche Lifestyle GmbH & Co. KG, Ludwigsburg (DE)

(72) Inventors: Christophe Brugger, Neuchâtel (CH); Franco Braiotta, Erlinsbach (CH)

(73) Assignee: Porsche Lifestyle GmbH & Co. KG, Ludwigsburg (DE)

(21) Appl. No.: 18/205,605

(22) Filed: Jun. 5, 2023

(30) Foreign Application Priority Data
Jun. 7, 2022 (DE) 10 2022 114 229.9

(51) Int. Cl. G04B 37/22; G04B 37/05

(52) U.S. Cl. CPC G04B 37/22; G04B 37/05

(57) ABSTRACT

A watchcase base body is formed from a mixed ceramic including titanium carbide and silicon carbide. A method for manufacturing a watch, wherein the watchcase base body is manufactured by liquid phase sintering.

### CROSS-REFERENCE TO RELATED APPLICATION

This application claims priority to German Patent Application No. 10 2022 114 229.9, filed Jun. 7, 2022, the content of such application being incorporated by reference herein in its entirety.

### FIELD OF THE INVENTION

The invention relates to a watchcase base body, a watch, in particular a wristwatch, and a method of manufacturing a watch.

### BACKGROUND OF THE INVENTION

A watch is known from EP 2 952 978B1 A1, which is incorporated by reference herein, in which a trim part partially consists of a ceramic, which can comprise titanium carbide.

A watch is known from CH 715 153A2, which is incorporated by reference herein, in which a crown is made from a ceramic substrate, which can comprise titanium carbide or silicon carbide.

A watch is known from EP 2 172 816B1, which is incorporated by reference herein, in which a case frame body is made of a carbide alloy, which can comprise titanium carbide.

### SUMMARY OF THE INVENTION

Described herein is a light and robust watch. The watchcase base body according to aspects of the invention consists entirely of a mixed ceramic comprising titanium carbide and silicon carbide. Preferably, the mixed ceramic consists solely of titanium carbide and silicon carbide. This creates a relatively light yet mechanically robust watchcase base body and therefore allows the implementation of a light and robust watch.

Preferably, the watchcase base body is manufactured from a ceramic granulate having a titanium carbide content of 50% to 70% and a silicon carbide content of 30% to 50%. This creates a particularly lightweight and robust watchcase base body.

Due to the fact that the watch according to aspects of the invention comprises a watchcase base body according to the invention, it is relatively light and yet robust.

Because technical elements such as threads, sealing seats, grooves, etc. can only be realized on the watchcase base body according to aspects of the invention with great effort, the watch according to aspects of the invention preferably comprises a clockwork carrier arranged in the watchcase base body and carrying a clockwork of the watch. This creates a relatively easily manufacturable watch.

It is expressly pointed out that a clockwork carrier according to aspects of the invention can in principle also be used in conjunction with a watchcase base body consisting of another ceramic or a different particularly hard material.

In a particularly preferred embodiment of the watch according to the invention, the clockwork carrier further carries a crown, at least one pusher element, and/or a watchglass. This creates a particularly easily manufacturable watch.

Preferably, the clockwork carrier consists of titanium.

Typically, two wristband fasteners are configured on the watchcase base body in order to fasten a wristband. Preferably, the clockwork carrier is fastened to the watchcase base body by means of screws, wherein the screws are arranged in the wristband fasteners such that the screws are obscured by a wristband fastened to the wristband fasteners. This allows a reliable fastening of the watch carrier to the watchcase base body, which does not impair the overall visual impression of the watch.

In the method according to aspects of the invention for manufacturing a watch, a watchcase base body consisting of a mixed ceramic comprising titanium carbide and silicon carbide is manufactured by means of liquid phase sintering. This creates a relatively light and robust watch.

Preferably, watchcase base body is manufactured from a ceramic granulate having a titanium carbide content of 50% to 70% and a silicon carbide content of 30% to 50%. This creates a particularly light and robust watch.

Preferably, the ceramic granulate is manufactured in an inexpensive manner by means of spray granulation.

Preferably, a green body blank is manufactured by means of pressing, particularly preferably by means of isostatic pressing, from a ceramic granulate, and a watchcase base body green body is subsequently formed from the green body blank by means of mechanical processing. This enables a reliable production of even relatively complex watchcase base bodies.

Because technical elements such as threads, sealing seats, grooves, etc. can only be realized on the watchcase base body manufactured according to aspects of the invention with great effort, a clockwork carrier carrying a clockwork is preferably inserted into the watchcase base body and fastened thereto. This allows the watch to be manufactured particularly easily.

For further simplification of the manufacture, a watchglass is preferably fastened to the clockwork carrier before the clockwork carrier is inserted into the watchcase base body.

Further, a crown and/or at least one pusher element is preferably fastened to the clockwork carrier for further simplification of the manufacture after insertion of the clockwork carrier into the watchcase base body.

### BRIEF DESCRIPTION OF THE DRAWINGS

An embodiment example of the present invention is described below with reference to the accompanying figures. The following are shown:

FIG. 1 is a schematic exploded view of a watch according to aspects of the invention with a watchcase base body according to the invention,

FIG. 2 is a schematic cross-sectional illustration of the watch from FIG. 1, and

FIG. 3 is a schematic illustration of a manufacturing process of the watchcase base body from FIG. 1.

### DETAILED DESCRIPTION OF THE INVENTION

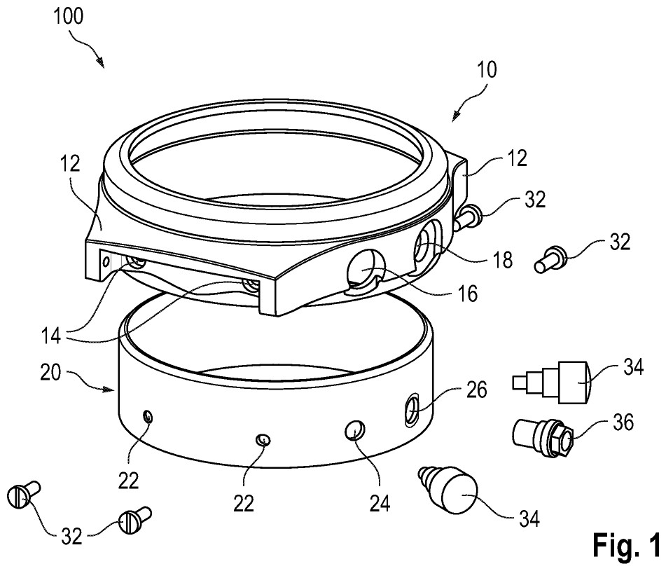

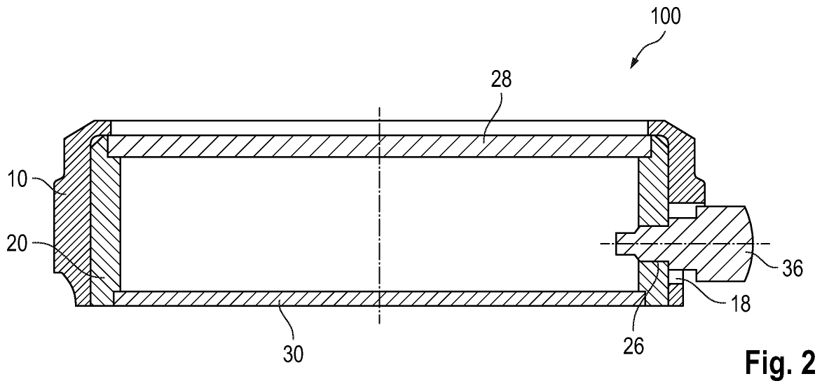

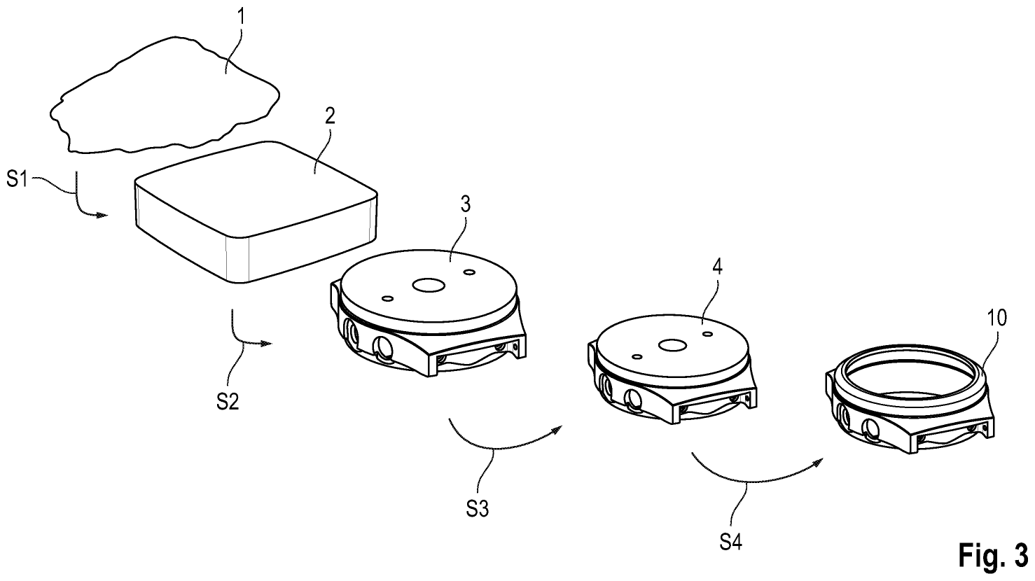

FIG. 1 and FIG. 2 show a watch 100 having a watchcase base body 10. The watchcase base body 10 consists entirely of a mixed ceramic comprising titanium carbide and silicon carbide and is manufactured as schematically shown in FIG. 3.

The watchcase base body 10 is specifically manufactured from a ceramic granulate 1 having a titanium carbide content of 60% and a silicon carbide content of 40% and having been manufactured by spray granulation.

A green body blank 2 is manufactured from the ceramic granulate 1 in a step S1 by isostatic pressing. A watchcase base body green body 3 is subsequently formed from the green body blank 2 in a step S2 by means of mechanical processing. The watchcase base body green body 3 is subsequently liquid-phase-sintered in a step S3, whereby a watchcase base body blank 4 is created. By means of hard machining, the finished watchcase base body 10 is manufactured in a step S4 from the watchcase base body blank 4.

Two opposing wristband fasteners 12 are formed on the watchcase base body 10. Four screw passage openings 14, two pusher element passage openings 16, and a crown passage opening 18 are further configured in the watchcase base body 10. The screw passage openings 14 are arranged within the wristband fasteners 12 such that the screw passage openings 14 are obscured by a wristband (not shown here) fastened to the wristband fasteners 12.

In the assembled state of the watch 100, a substantially annular clockwork carrier 20 is arranged in the watchcase base body 10, which carrier consists of titanium and carries a clockwork (not shown herein) of the watch 100 in its interior. Four screw receptacles 22, two pusher element receptacles 24, and a crown receptacle 26 are configured on the clockwork carrier 20, which are arranged corresponding to the four screw passage openings 14, the two pusher element passage openings 16, and the crown passage opening 18 of the watchcase base body 10. A watchglass 28 is arranged on a front side of the clockwork carrier 20, and a lid 30 is arranged on a rear side of the clockwork carrier 20, each of which is fastened to the clockwork carrier 20.

When the watch 100 is assembled, the clockwork as well as any other present technology is mounted in the clockwork carrier 20, and the clockwork carrier 20 is subsequently closed by fastening the watchglass 28 and the lid 30. The pre-assembled clockwork carrier 20 is then inserted into the watchcase base body 10 and fastened to the watchcase base body 10 with the aid of four screws 32, each extending through screw passage openings 14 of the watchcase base body 10 and engaging one of the screw receptacles 22 of the clockwork carrier 20. Because the screw passage openings 14 are arranged within the wristband fasteners 12, the screws 14 are obscured by the wristband fastened to the wristband fasteners 12 in the fully assembled state of the watch 100.

After the clockwork carrier 20 has been inserted into the watchcase base body 10, two pusher elements 34 and a crown 36 are fastened to the clockwork carrier 20. The pusher elements 34 each extend through one of the pusher element passage openings 16 of the watchcase base body 10 and are fastened in one of the pusher element receptacles 24 of the clockwork carrier 20, and the crown 36 extends through the crown passage opening 18 of the watchcase base body 10 and is fastened in the crown receptacle 26 of the clockwork carrier 20.

What is claimed is:

1. A watchcase base body formed of a mixed ceramic including titanium carbide and silicon carbide.

2. The watchcase base body according to claim 1, wherein the watchcase base body comprises a ceramic granulate having a titanium carbide content of 50% to 70% and a silicon carbide content of 30% to 50%.

3. A watch having the watchcase base body according to claim 1.

4. The watch according to claim 3, further comprising a clockwork carrier including a clockwork that is arranged in the watchcase base body.

5. The watch according to claim 4, wherein the clockwork carrier further includes a crown, at least one pusher element, and/or a watchglass.

6. The watch according to claim 4, wherein the clockwork carrier is formed of titanium.

7. The watch according to claim 4, further comprising:
two wristband fasteners mounted to the watchcase base body, wherein the two wristband fasteners are further configured to be fastened to a wristband,
screws for fastening the clockwork carrier to the watchcase base body, wherein the screws are arranged in the wristband fasteners such that the screws are obstructed by the wristband fastened to the wristband fasteners.

8. The watchcase base body of claim 1, wherein the watchcase base body consists entirely of the mixed ceramic including titanium carbide and silicon carbide.

9. A method for manufacturing a watch, said method comprising forming, by liquid phase sintering, a watchcase base body of the watch from a mixed ceramic comprising titanium carbide and silicon carbide.

10. The method according to claim 9, wherein the watchcase base body is manufactured from a ceramic granulate having a titanium carbide content of 50% to 70% and a silicon carbide content of 30% to 50%.

11. The method according to claim 9, wherein the ceramic granulate is manufactured by spray granulation.

12. The method according to claim 9, wherein forming the watchcase base body comprises:
pressing a green body blank from a ceramic granulate, and
forming a watchcase base body green body from the green body blank by mechanical processing.

13. The method according to claim 9, further comprising inserting into the watchcase base body a clockwork carrier having a clockwork, and then fastening the clockwork carrier to the watchcase base body.

14. The method according to claim 13, wherein, prior to inserting the clockwork carrier into the watchcase base body, the method comprises fastening a watchglass to the clockwork carrier.

15. The method according to claim 13, wherein, after insertion of the clockwork carrier into the watchcase base body, the method further comprises fastening a crown and/or at least one pusher element onto the clockwork carrier.

16. The method according to claim 9, wherein the watchcase base body consists entirely of the mixed ceramic including titanium carbide and silicon carbide.
